(19) United States
(12) Patent Application Publication
(10) Pub. No.: US 2026/0360742 A1
(43) Pub. Date: Nov. 12, 2026

(54) SELF-SUPPORTING ELECTRODE FILM AND MANUFACTURING METHOD THEREOF

(71) Applicant: TOYOTA JIDOSHA KABUSHIKI KAISHA, Toyota-shi (JP)

(72) Inventor: Masashi UEDA, Toyota-shi (JP)

(73) Assignee: TOYOTA JIDOSHA KABUSHIKI KAISHA, Toyota-shi (JP)

(21) Appl. No.: 19/536,443

(22) Filed: Feb. 11, 2026

(30) Foreign Application Priority Data
May 9, 2025 (JP) 2025-078606

(51) Int. Cl. H01M 4/62; H01M 4/36; H01M 10/052; H01M 10/0525; H01M 4/02

(52) U.S. Cl. CPC H01M 4/623; H01M 4/366; H01M 4/625; H01M 10/052; H01M 10/0525; H01M 2004/021

(57) ABSTRACT

The present disclosure relates to a self-supporting electrode film and a manufacturing method thereof. The self-supporting electrode film includes carbon-based active material particles, SiC active material particles, carbon nanotubes that are unevenly distributed on a surface or in the vicinity of the surface of the SiC active material particles, and a first binder having a fibrillated form.

### CROSS-REFERENCE TO RELATED APPLICATION

This application claims priority to Japanese Patent Application No. 2025-078606 filed on May 9, 2025. The disclosure of the above-identified application, including the specification, drawings, and claims, is incorporated by reference herein in its entirety.

### BACKGROUND

### 1. Technical Field

The technology disclosed in the present specification relates to a self-supporting electrode film and a manufacturing method thereof.

### 2. Description of Related Art

In recent years, a self-supporting electrode film has been manufactured by a dry process. For example, a self-supporting electrode film containing polytetrafluoroethylene (PTFE) is known (U.S. Patent Application Publication No. 2024/0105955 (US 2024/0105955 A)). In US 2024/0105955 A, a composite binder in which polyvinylidene fluoride (PVDF) and polyether oxide (PEO) are combined is used in order to improve a binding performance while PTFE is used as a main binder. In the method, a mixture of active material particles, a conductive auxiliary agent, and the composite binder is prepared, and PTFE is fibrillated by applying a shearing force, and then the mixture is pressed to form the self-supporting electrode film.

For example, a silicon-based active material particle such as SiC may be used as a negative electrode active material particles.

### SUMMARY

However, it has been found that, even in a case where the self-supporting electrode film is produced by the method of US 2024/0105955 A, a decrease in electron conductivity due to expansion and contraction of the SiC active material particles tends to be large, and a capacity retention rate of a secondary battery including the self-supporting electrode film is decreased.

The present specification provides a self-supporting electrode film in which expansion and contraction of SiC active material particles are effectively suppressed, and a technology of manufacturing the self-supporting electrode film.

The technology disclosed in the present specification is embodied in a self-supporting electrode film.

The self-supporting electrode film includes:
carbon-based active material particles;
SiC active material particles;
carbon nanotubes unevenly distributed on a surface of the SiC active material particles or in a vicinity of the surface of the SiC active material particles; and
a first binder having a fibrillar form.

The self-supporting electrode film can include the SiC active material particles and the carbon nanotubes in a form in which the carbon nanotubes are unevenly distributed on the surface of the SiC active material particles or in the vicinity thereof. Therefore, the decrease in electron conductivity due to expansion and contraction of the SiC active material particles is effectively suppressed by the carbon nanotubes. As a result, the decrease in the capacity retention rate of the secondary battery including the self-supporting electrode film is suppressed.

The technology disclosed in the present specification is also embodied in a manufacturing method of a self-supporting electrode film.

The manufacturing method includes:
removing a solvent from a mixture containing SiC active material particles, carbon nanotubes, and the solvent to prepare a first mixture containing composite SiC active material particles having a composite form in which at least a part of a surface of the SiC active material particles is coated with the carbon nanotubes;
mixing the first mixture, carbon-based active material particles, and a first binder that is fibrillatable, by a dry process to prepare a second mixture;
fibrillating the first binder in the second mixture to prepare a third mixture containing the first binder having a fibrillated form; and
pressurizing and molding the third mixture to produce the self-supporting electrode film.

With the manufacturing method of the self-supporting electrode film, the solvent is removed (“dry-up”), and at least a part of the surface of the SiC active material particles is coated with the carbon nanotubes to obtain the first mixture containing the composite SiC active material particles. By preparing the first mixture in advance and then mixing the first mixture by a “dry process” to obtain the second mixture, the composite form of the composite SiC active material particles is maintained. Therefore, the composite SiC active material particles are retained in the self-supporting electrode film. With the manufacturing method, the SiC active material particles and the carbon nanotubes are included in a form in which at least a part of the surface of the SiC active material particles is selectively coated with the carbon nanotubes. As a result, it is possible to easily obtain a self-supporting electrode film in a form in which the carbon nanotubes are unevenly distributed on the surface of the SiC active material particles or in the vicinity thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an example of a cell of a lithium ion secondary battery;

FIG. 2 is a diagram schematically showing a structure of the self-supporting electrode film disclosed in the present specification and showing the composite SiC active material particles in an enlarged manner;

FIG. 3 is a flowchart showing an example of a manufacturing method of the self-supporting electrode film;

FIG. 4 is a diagram showing measurement results of an interfacial resistance between the self-supporting electrode film and a collector in Examples and Comparative Examples;

FIG. 5 is a diagram showing measurement results of a direct current resistance in the cells of Examples and Comparative Examples; and

FIG. 6 is a diagram showing measurement results of a capacity retention rate in the cells of Examples and Comparative Examples.

### DETAILED DESCRIPTION OF EMBODIMENTS

Hereinafter, the self-supporting electrode film and a manufacturing method thereof will be described with reference to the drawings as appropriate. The present specification includes the following configurations.
[1] A self-supporting electrode film comprising: carbon-based active material particles; SiC active material particles; carbon nanotubes that are unevenly distributed on a surface or in the vicinity of the surface of the SiC active material particles; and a first binder having a fibrillated form.
[2] The self-supporting electrode film according to [1], in which the self-supporting electrode film includes composite SiC active material particles having a composite form in which at least a part of a surface of the SiC active material particles is coated with the carbon nanotubes.
[3] The self-supporting electrode film according to [1] or [2], in which the first binder includes polytetrafluoroethylene.
[4] A lithium ion secondary battery comprising: the self-supporting electrode film according to any one of [1] to [3] as a negative electrode film.
[5] A manufacturing method of a self-supporting electrode film, comprising: removing a solvent from a mixture including SiC active material particles, carbon nanotubes, and a solvent to prepare a first mixture including composite SiC active material particles having a composite form in which at least a part of a surface of the SiC active material particles is coated with the carbon nanotubes; mixing the first mixture, carbon-based active material particles, and a first binder that can be fibrillated, by a dry process to prepare a second mixture; fibrillating the first binder in the second mixture to prepare a third mixture including the first binder having a fibrillated form; and pressurizing and molding the third mixture to produce the self-supporting electrode film.
[6] The manufacturing method according to [5], in which preparing the first mixture includes mixing the SiC active material particles and a paste in which the carbon nanotubes are dispersed in the solvent to obtain the mixture.

In the present specification, the self-supporting electrode film is, for example, a self-supporting electrode film constituting a negative electrode of a lithium ion secondary battery. The self-supporting electrode film is an electrode film that can be self- supporting by itself, in which active material particles and the like are entangled by a fibrillated binder.

### Self-supporting Electrode Film

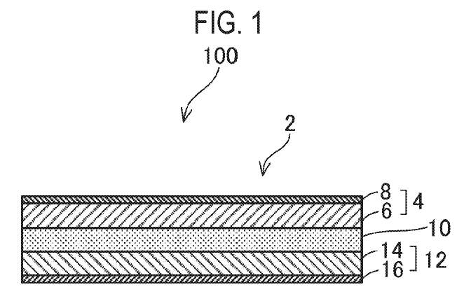

FIG. 1 schematically shows an example of a cell 2 of a lithium ion secondary battery (hereinafter, simply referred to as a secondary battery) 100. As shown in FIG. 1, the cell 2 as a unit structure of the secondary battery 100 includes a positive electrode 4, a separator 10, and a negative electrode 12. The secondary battery 100 usually has a structure in which a plurality of cells 2 are laminated.

The positive electrode 4 can include a known positive electrode active material, a conductive auxiliary agent, a binder, and the like in a positive electrode layer 6. The positive electrode layer 6 is not particularly limited, but may be, for example, a self-supporting electrode film produced using a binder that can be fibrillated as at least a part of a binder. The positive electrode layer 6 appropriately includes a positive electrode collector 8.

The separator 10 may hold, for example, a liquid or gel-like electrolyte. The separator 10 is made of a known material such as a polyolefin-based microporous film in which fine voids are formed. The separator 10 is impregnated with a liquid electrolyte containing a lithium salt such as lithium hexafluorophosphate with an organic solvent such as ethylene carbonate (EC), dimethyl carbonate (DMC), and diethyl carbonate (DEC) as a medium. Instead of these, a solid electrolyte layer may be used.

The negative electrode 12 includes a self-supporting electrode film 14 including carbon-based active material particles 20, SiC active material particles 22 and carbon nanotubes 24 (or composite SiC active material particles 26), and a first binder 28. The self-supporting electrode film (hereinafter, also referred to as an electrode film) 14 appropriately includes a negative electrode collector 16.

### Carbon-based Active Material Particle

As the carbon-based active material particles 20, known carbon-based active material particles can be used. Examples thereof include graphite such as natural graphite and artificial graphite, soft carbon, and hard carbon. The carbon-based active material particles 20 have stable charge and discharge characteristics. A content of the carbon-based active material particles in the electrode film 14 is not particularly limited, but is, for example, 20% by mass or more and 80% by mass or less with respect to the total mass of all materials (the carbon-based active material particles 20, the SiC active material particles 22, the CNT 24, the first binder 28, and the like) constituting the electrode film 14. In addition, the content is 30% by mass or more, 40% by mass or more, 50% by mass or more, 60% by mass or more, and 70% by mass or more. Further, the content is 80% by mass or less, 70% by mass or less, 60% by mass or less, and 50% by mass or less. The range of the content of the carbon-based active material particles can be set by appropriately combining the upper limit and the lower limit described above in addition to the above-described range. The range of the content of the carbon-based active material particles is, for example, 40% by mass or more and 80% by mass or less, 50% by mass or more and 80% by mass or less, 60% by mass or more and 80% by mass or less, or 70% by mass or more and 80% by mass or less. In addition, the average particle diameter by a laser diffraction and scattering method is not particularly limited, but can be, for example, 1 μm or more and 50 μm or less, or 5 μm or more and 20 μm or less.

### SiC Active Material Particles and Carbon Nanotubes, CNT

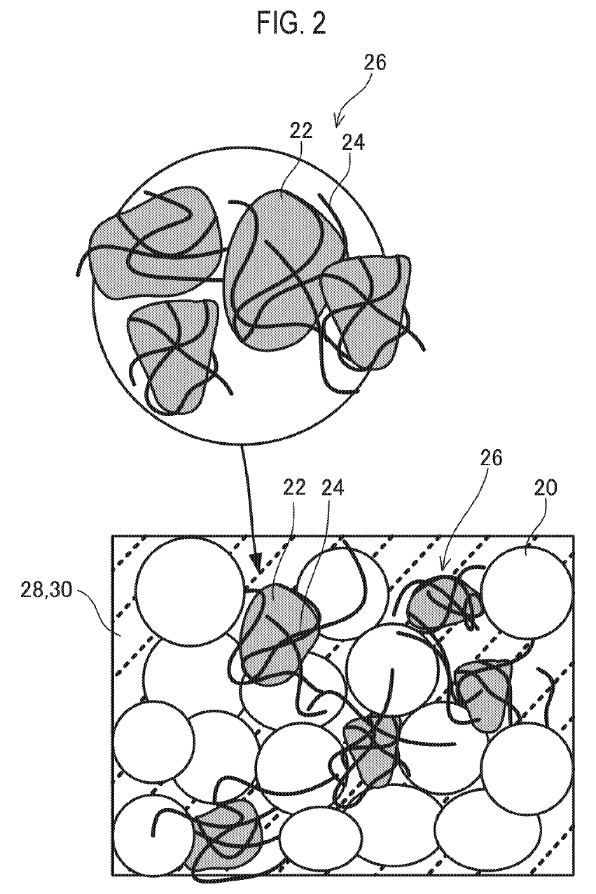

As shown in FIG. 2, the electrode film 14 includes the SiC active material particles 22 and the CNT 24 in a form in which the CNT 24 is unevenly distributed on a surface or in the vicinity of the surface of the SiC active material particles 22. The CNT 24 can have high electron conductivity, high strength, and a high surface area. In the electrode film 14, as in the related art, the CNT 24 is not uniformly dispersed in the entire electrode film 14, for example, to form a network. In this manner, the decrease in electron conductivity that may occur due to expansion and contraction of the SiC active material particles 22 can be effectively suppressed.

As the SiC active material particles 22, in addition to the SiC active material particles such as β-SiC active material particles, SiC active material particles doped with nitrogen atoms, phosphorus atoms, or the like may be used. The doped SiC active material particles may have excellent conductivity and lithium ion conductivity. A shape of the SiC active material particles 22 is not particularly limited, and known particles having an appropriate shape can be used. The SiC active material particles are, for example, irregular particles or whiskers. An average particle diameter of the SiC active material particles 22 is appropriately set in consideration of the mixing properties, the composite with the CNT 24 described later, and the like. The average particle diameter by a laser diffraction and scattering method is not particularly limited, but can be, for example, 1 μm or more and 50 μm or less, or 5 μm or more and 20 μm or less. The SiC active material particles 22 may be preferably irregular in shape. The composite will be described later.

Examples of the CNT 24 include a single-wall carbon nanotube (SW-CNT), and a multi-wall carbon nanotube (MW-CNT) including a double-wall carbon nanotube (DW-CNT). As the CNT 24, one kind or two or more kinds of such CNTs can be used in combination. An average particle diameter of the CNT 24 is appropriately set in consideration of the mixing properties, the composite with the SiC active material particles 22, and the like.

### Composite SiC Active Material Particles

In the electrode film 14, as one aspect of the form in which the CNT 24 is unevenly distributed on a surface or in the vicinity of the surface of the SiC active material particles 22, the electrode film 14 includes composite SiC active material particles 26 having a composite form in which at least a part of the surface of the SiC active material particles 22 is coated with the CNT 24. The composite SiC active material particles 26 are enlarged and shown in FIG. 2.

In the electrode film 14 including the composite SiC active material particles 26, the CNT 24 is distributed on the SiC active material particles 22 and is unevenly distributed on the surface of the SiC active material particles 22 in a selective manner. By including the composite SiC active material particles 26, the decrease in electron conductivity that may occur due to expansion and contraction of the SiC active material particles 22 can be further effectively suppressed.

In the composite SiC active material particles 26, the CNT 24 may coat a part of the surface of the SiC active material particles 22, but may coat the entire surface. In a case where the CNT 24 that is not composite with the SiC active material particles 22 is further included, the CNT 24 is uniformly dispersed in the entire electrode film 14.

A content of the SiC active material particles 22 in the electrode film 14 is not particularly limited, but is, for example, 5% by mass or more and 60% by mass or less with respect to the total mass of the materials constituting the electrode film 14. In addition, for example, the content is 10% by mass or more, 15% by mass or more, 20% by mass or more, 30% by mass or more, and 40% by mass or more. In addition, the content is 55% by mass or less, 50% by mass or less, 45% by mass or less, and 40% by mass or less. In addition, the range of the content of the composite SiC active material particles 26 can be 15% by mass or more and 50% by mass or less, 15% by mass or more and 40% by mass or less, 15% by mass or more and 25% by mass or less, or 15% by mass or more and 20% by mass or less.

A content of the CNT 24 in the electrode film 14 is not particularly limited, but can be 0.05% by mass or more and 3.0% by mass or less, 0.05% by mass or more and 2.5% by mass or less, or 0.05% by mass or more and 1.5% by mass or less. A mass ratio of the CNT 24 to the SiC active material particles 22 is not particularly limited. A mass ratio of the CNT 24 to the SiC active material particles 22 is, for example, 1 part by mass or more and 4 parts by mass or less, 1 part by mass or more and 3 parts by mass or less, or 1 part by mass or more and 2 parts by mass or less with respect to 100 parts by mass of the SiC active material particles 22.

A content of the composite SiC active material particles 26 in the electrode film 14 is not particularly limited, but is, for example, 5% by mass or more and 60% by mass or less with respect to the total mass of the materials constituting the electrode film 14. In addition, for example, the content is 10% by mass or more, 15% by mass or more, 20% by mass or more, 30% by mass or more, and 40% by mass or more. In addition, the content is 55% by mass or less, 50% by mass or less, 45% by mass or less, and 40% by mass or less. In addition, the range of the content of the composite SiC active material particles 26 can be 15% by mass or more and 50% by mass or less, 15% by mass or more and 40% by mass or less, 15% by mass or more and 25% by mass or less, or 15% by mass or more and 20% by mass or less.

A mass ratio of the CNT 24 to the SiC active material particles 22 in the composite SiC active material particles 26 is as described above. In the electrode film 14 including the composite SiC active material particles 26, all of the SiC active material particles 22 and the CNT 24 may not be composite. A total mass of the composite SiC active material particles 26, the SiC active material particles 22, and the CNT 24 can be in the same mass ratio as the content of the composite SiC active material particles 26.

The electrode film 14 may include active material particles other than the carbon-based active material particles 20 and the composite SiC active material particles 26 as the active material particles. The active material particles are not particularly limited, but examples thereof include particles of Si, SiO, tin oxide, and lithium titanate.

In addition, the electrode film 14 may include a known conductive auxiliary agent other than the CNT as the conductive auxiliary agent. Examples of the conductive auxiliary agent include carbon black such as graphene, acetylene black, Ketjen black, channel black, furnace black, lamp black, and summer black.

### First Binder

The first binder 28 is a polymer having a fibrillated form (hereinafter, simply referred to as a fibrillated form) in the electrode film 14. The first binder 28 is derived from a polymer that can be fibrillated. In a case where a predetermined shearing force is applied to the polymer that can be fibrillated, the polymer is fibrillated, that is, the polymer is subdivided and changed into a fiber shape. As a result, the polymer having a fibrillated form can form a network. Therefore, the polymer having a fibrillated form can entangle and immobilize the active material particles in a fiber shape to impart mechanical strength and contribute to the self-supporting property of the self-supporting electrode film. In FIG. 2, the first binder 28 and a second binder 30 described later are both simplified.

As the first binder 28, a known polymer that can be fibrillated can be used without particular limitation. Examples of the polymer that can be fibrillated include polytetrafluoroethylene (PTFE), polyolefin, polyalkylene, polyether, styrene-butadiene, polysiloxane, a copolymer of polysiloxane, branched polyether, polyvinyl ether, and a copolymer thereof. Further, cellulose including carboxyalkyl cellulose such as carboxymethyl cellulose (CMC) is exemplified. As the fibrillar polymer, one kind or two or more kinds of these can be used. For example, the fibrillar polymer may be preferably PTFE. This is because the PTFE has excellent fibrillating properties and binder properties.

A content of the first binder 28 in the electrode film 14 is not particularly limited, and may be a content that can immobilize and integrate the constituent materials of the electrode film 14. The content of the first binder 28 is, for example, 1.0% by mass or more and 10% by mass or less with respect to the total mass of the materials constituting the electrode film 14. In addition, for example, the content is 1.5% by mass or more, 2.0% by mass or more, 2.5% by mass or more, 3.0% by mass or more, and 4.0% by mass or more. In addition, the content is 9.0% by mass or less, 8.0% by mass or less, 7.0% by mass or less, 6.0% by mass or less, 5.0% by mass or less, 4.5% by mass or less, and 3.5% by mass or less. The range of the content of the first binder 28 can be set by appropriately combining the lower limit and the upper limit of the above-described range. For example, the content is 1.5% by mass or more and 4.5% by mass or less, 2.0% by mass or more and 4.0% by mass or less, or 2.5% by mass or more and 3.5% by mass or less.

### Second Binder

The electrode film 14 can contain a second binder 30 as necessary. The second binder 30 is added to the electrode film 14 in addition to the first binder 28 as necessary. The second binder 30 is a polymer that is not fibrillated. The second binder 30 is used from the viewpoint of binder properties or lithium ion conductivity. The second binder 30 is not particularly limited, and examples thereof include polyvinylidene fluoride (PVDF), polyethylene oxide (PEO), polypropylene oxide, polyacrylonitrile, polyvinyl chloride, polymethyl methacrylate, ethylene carbonate, polyethylene, polypropylene, polystyrene, an ABS resin, polyacrylate, polymethacrylate, polyvinyl alcohol, and polycarbonate. One kind or two or more kinds of these can be used.

A content of the second binder 30 in the electrode film 14 is not particularly limited, and is determined as necessary from the viewpoint of binder properties or lithium ion conductivity. The content of the second binder 30 is, for example, 1.0% by mass or more and 10% by mass or less with respect to the total mass of the materials constituting the electrode film 14 including the first binder 28 described above. In addition, for example, the content is 1.5% by mass or more, 2.0% by mass or more, 2.5% by mass or more, 3.0% by mass or more, and 4.0% by mass or more. In addition, the content is 9.0% by mass or less, 8.0% by mass or less, 7.0% by mass or less, 6.0% by mass or less, 5.0% by mass or less, 4.5% by mass or less, and 3.5% by mass or less. The range of the content of the second binder 30 can be set by appropriately combining the lower limit and the upper limit of the above-described range. For example, the content is 1.5% by mass or more and 4.5% by mass or less, or 2.0% by mass or more and 4.0% by mass or less.

A total amount of the first binder 28 and the second binder 30 is preferably 10% by mass or less with respect to the total mass of the materials constituting the electrode film 14. In addition, the total amount may be 9% by mass or less, 8% by mass or less, 7% by mass or less, or 6% by mass or less.

The electrode film 14 may contain a polymer that functions as a binder as necessary. Such a polymer can be, for example, a known polymer that can be used for this kind of electrode film, in addition to the first binder 28 and the second binder 30 described above. The electrode film 14 described above can have, for example, a thickness of about several μm or more and 2000 μm or less.

According to the electrode film 14, since the composite SiC active material particles 26 are included, the expansion and contraction of the SiC active material particles 22 due to charging and discharging are effectively suppressed, and the decrease in electron conductivity of the SiC active material particles 22 is suppressed. As a result, the decrease in the capacity retention rate of the secondary battery 100 including the electrode film 14 can be suppressed. In addition, the SiC active material particles 22 can also contribute to high capacity.

As will be described later, the electrode film 14 is suitably produced by “drying” and a “dry process”. The electrode film 14 does not contain or substantially does not contain a solvent.

In addition, according to the present specification, a secondary battery 100 including the electrode film 14 is also provided.

### Manufacturing Method of Self-supporting Electrode Film

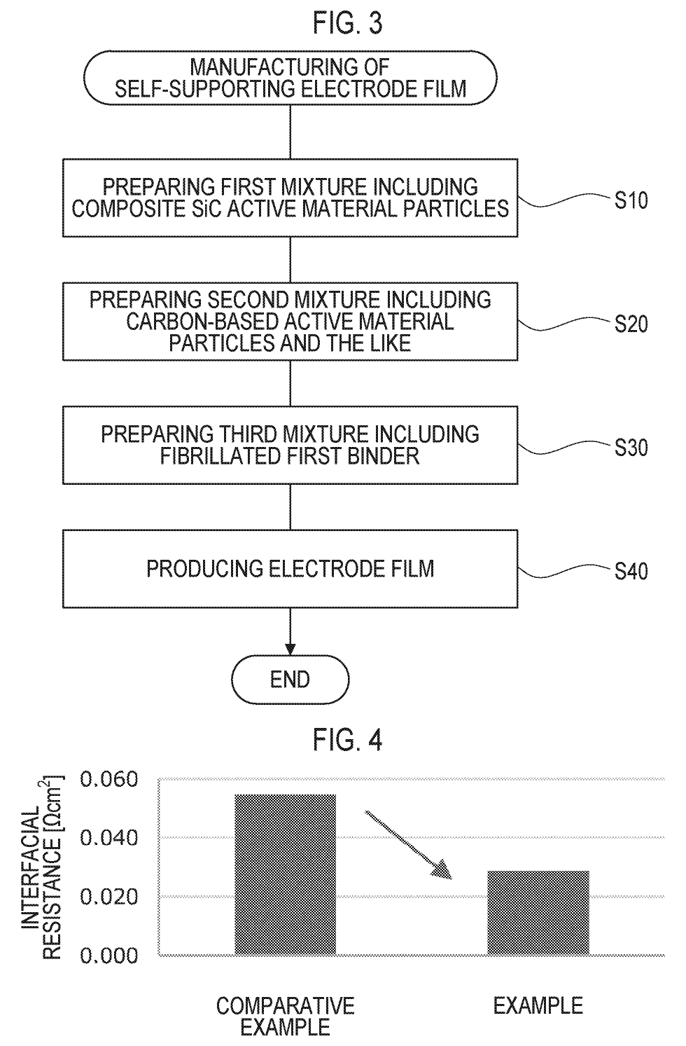

Next, a suitable method of producing the electrode film 14 will be described with reference to FIG. 3 as appropriate. The manufacturing method includes a step S10 of preparing a first mixture, a step S20 of preparing a second mixture, a step S30 of preparing a third mixture, and a step S40 of producing the self-supporting electrode film 14.

### Step S10 of Preparing First Mixture

The step S10 is a step of removing a solvent from a mixture including the SiC active material particles 22, the CNT 24, and a solvent to prepare a first mixture including composite SiC active material particles 26 having a composite form in which at least a part of a surface of the SiC active material particles 22 is coated with the CNT 24. In the step S10, the solvent is removed from the mixture including the SiC active material particles 22, the CNT 24, and the solvent by any method (“drying”). Therefore, the composite form in which the surface of the SiC active material particles 22 is coated with the CNT 24 is formed, and the first mixture including the composite SiC active material particles 26 can be obtained.

The mixture does not include or substantially does not include the carbon-based active material particles 20, the first binder 28, and the second binder 30. Here, the fact that a certain material is not substantially included means that the material is not included at all or is included only in an amount that does not exhibit a technical significance. By not including the carbon-based active material particles 20, the first binder 28, and the like, the CNT 24 can be composited to selectively coat the surface of the SiC active material particles 22.

As the SiC active material particles 22 and the CNT 24 used in the step S10, the various aspects of the SiC active material particles 22 and the CNT 24 described for the electrode film 14 can be used. The SiC active material particles 22 and the CNT 24 are used in a size such that the surface of the SiC active material particles 22 is coated with the CNT 24. In addition, the SiC active material particles 22 and the CNT 24 can be used in the mass ratio described above.

The solvent is not particularly limited as long as the CNT 24 can be dispersed in the solvent. For example, a non-protonic polar solvent such as N-methyl-2-pyrrolidone (NMP), dimethylformamide (DMF), or dimethyl sulfoxide (DMSO) can be appropriately used. In addition, a polar solvent such as water or a lower alcohol may be used. In addition, a mixed solution thereof may be used as appropriate.

The solvent is used in an amount that can disperse the CNT 24 to a degree that the surface of the SiC active material particles 22 can be coated. The solvent may be used, for example, as a solvent of a CNT paste in which the CNT 24 is dispersed and held in advance. In the step S10, the mixture can be prepared by mixing the SiC active material particles 22 and the paste in which the CNT 24 is dispersed in the solvent. In this manner, the CNT 24 that is well dispersed is supplied to the SiC active material particles 22, and as a result, the composite of coating the surface of the SiC active material particles 22 with the CNT 24 can be easily realized.

In preparing such a mixture, a known mixer can be appropriately used. In order to remove the solvent (dry) from such a mixture, the mixture is dried such that the composite form of the SiC active material particles 22 and the CNT 24 is maintained. For example, from the viewpoint of maintaining the composite form, it is preferable to use, as the drying method, conduction drying, radiation drying, or vacuum drying alone or in combination of two or more kinds thereof. The obtained first mixture is appropriately crushed.

### Step S20 of Preparing Second Mixture

The step S20 is a step of mixing the first mixture, the carbon-based active material particles 20, and the first binder 28 that can be fibrillated by a “dry process” to prepare a second mixture. In the present step, the carbon-based active material particles 20, the SiC active material particles 22, the CNT 24, the first binder 28, and the like in the first mixture are used such that the mass ratio thereof to the materials constituting the electrode film 14 is the above-described mass ratio. In a case where the second binder 30 is used, the second binder 30 is added in the present step.

The “dry process” means a process in a state of not containing or substantially not containing a solvent. By adopting the “dry process”, the CNT 24 constituting the composite SiC active material particles 26 obtained in the step S10 can be maintained in a composite state in which the surface of the SiC active material particles 22 is coated. This is because, in the “wet process” using the solvent, the CNT 24 is dispersed in the solvent again, making it difficult to selectively coat the surface of the SiC active material particles 22.

In preparing the second mixture, a known mixer can be appropriately used. In preparing the second mixture, the composite SiC active material particles 26 are mixed to be maintained. In addition, the first binder 28 that can be fibrillated can be mixed under a condition in which the first binder 28 is not fibrillated in order to be uniformly dispersed. Such mixing conditions can be appropriately set by those skilled in the art.

### Step S30 of Preparing Third Mixture

The step S30 is a step of fibrillating the first binder 28 in the second mixture to prepare a third mixture. The third mixture includes the first binder 28 in a fibrillar form. As the first binder 28 is fibrillated, the first binder 28 has a network form capable of immobilizing the carbon-based active material particles 20, the composite SiC active material particles 26, and the like. Therefore, the third mixture can form a self-supporting film by pressurization and molding. The step S30 is a “dry process” in which a solvent is not used or substantially not used.

Conditions for fibrillating the first binder 28, such as a shearing force, are well known to those skilled in the art, and those skilled in the art can appropriately set the conditions for fibrillating the first binder 28. For example, the third mixture can be mixed using a known mixer such as a kneader to fibrillate the first binder 28.

### Step S40 of Producing Electrode Film

The step S40 is a step of pressurizing and molding the third mixture to produce the electrode film 14. By pressurization and molding, the self-supporting electrode film 14 can be obtained. In the pressurization and molding, for example, a film can be formed using a device that performs compression rolling, such as a roll press. The electrode film 14 is cut or the like as necessary.

The obtained electrode film 14 contains the composite SiC active material particles 26, and thus the CNT 24 is distributed in a form of being more selectively present (unevenly distributed) on the surface or in the vicinity of the surface of the SiC active material particles 22. Therefore, the expansion and contraction of the SiC active material particles 22 due to charging and discharging are suppressed by the CNT 24, and the decrease in electron conductivity of the SiC active material particles 22 is suppressed. In addition, since the electrode film 14 is produced by “drying” and a “dry process”, the electrode film 14 does not contain or substantially does not contain a solvent.

Using the self-supporting electrode film 14 obtained in this way, a secondary battery 100 including the positive electrode 4 and the separator 10 in addition to the other components of the secondary battery 100 and the negative electrode collector 16 is produced. The secondary battery 100 can be a secondary battery having a known various forms by a known winding method, a known laminating method, or the like.

According to the secondary battery 100, since the electrode film 14 contains the composite SiC active material particles 26, the expansion and contraction of the SiC active material particles 22 due to charging and discharging are suppressed by the CNT 24. As a result, the decrease in electron conductivity of the SiC active material particles 22 is suppressed. In addition, the CNT also ensures a conductive path. As a result, the decrease in the capacity retention rate of the secondary battery 100 due to charging and discharging is suppressed.

In the above description, the electrode film 14, the secondary battery 100, the manufacturing method of the electrode film 14, and the like have been mainly described, but according to the present specification, the composite SiC active material particles 26 used in the electrode film 14 are provided as active material particles for a self-supporting electrode film. In addition, the first mixture, the second mixture, and the third mixture including the composite SiC active material particles 26 are also provided as composite materials for a self-supporting electrode film.

In addition, in the above description, the manufacturing method of the self-supporting electrode film such as the electrode film 14 has been described, but a manufacturing method of the composite SiC active material particles 26 is also provided. According to the step S10 of preparing the first mixture, the first mixture including the composite SiC active material particles 26 can be obtained.

Further, according to the present specification, a manufacturing method of a composite material for an electrode film that is the second mixture or the third mixture, is also provided. In addition, a manufacturing method of the negative electrode 12 using the self-supporting electrode film 14 is also provided, in addition to each step in the manufacturing method of the self-supporting electrode film 14. Further, a manufacturing method of the secondary battery 100 including a step of producing the secondary battery 100 using the electrode is also provided.

According to the present specification, the following configurations are also included in addition to the configurations of [1] to [6] described above.
[7] Active material particles for a self-supporting electrode film, comprising: composite SiC active material particles having a composite form in which at least a part of a surface of SiC active material particles is coated with carbon nanotubes.
[8] A composite material for a self-supporting electrode film, comprising: composite SiC active material particles having a composite form in which at least a part of a surface of SiC active material particles is coated with carbon nanotubes.
[9] The composite material for a self-supporting electrode film according to [8], further comprising: carbon-based active material particles; and a first binder that can be fibrillated.
[10] The composite material for a self-supporting electrode film according to [9], further comprising: a second binder that is not fibrillated.
[11] The composite material for a self-supporting electrode film according to [9] or [10], in which the first binder has a fibrillated form.

Hereinafter, Examples in which the disclosure of the present specification is embodied will be described, but the Examples are for describing the disclosure of the present specification and are not limiting.

In the present Example, a self-supporting electrode film of a negative electrode of a lithium ion secondary battery was produced by the following method, and an evaluation electrode and an evaluation cell were further produced to perform electrode evaluation and cell evaluation.

As the active material particles of the negative electrode film, graphite particles (average particle diameter: 10 μm) and SiC active material particles (irregular shape, average particle diameter: 10 μm) were used in the self-supporting electrode film, and CNT was used as the conductive auxiliary agent, PTFE was used as the binder that can be fibrillated, and PVDF was used as the binder that is not fibrillated. In addition, the mass ratio (graphite:SiC:CNT:PTFE:PVDF) of these in the negative electrode film was set to 75.4:18.8:3.0:2.5.

### 1. Preparation of First Mixture

First, the SiC active material particles and the CNT paste including the CNT dispersed in NMP were mixed (2000 rpm, 5 minutes) with a mixer such that the mass ratio of the SiC active material particles to the CNT was in accordance with the above-described mass ratio. Thereafter, the mixture was dried on a hot plate at 120°C for 1 hour, and then vacuum-dried at 80°C for 8 hours. The obtained dried product was the first mixture in the present specification. As a result of observing the first mixture, it was confirmed that the CNT was coated on the surface of the SiC active material particles to entangle.

### 2. Preparation of Second Mixture

Graphite, PTFE, and PVDF were added to the first mixture such that the mass ratio was in accordance with the above-described mass ratio, and the mixture was mixed at 300 rpm for 180 seconds with a mixer, and further mixed at 3000 rpm for 8 minutes to obtain a second mixture.

### 3. Preparation of Third Mixture

The second mixture was mixed at 100°C for 180 seconds at 10 rpm with a batch kneader to fibrillate the PTFE, thereby obtaining a third mixture.

### 4. Production of Self-supporting Electrode Film

The third mixture was rolled with a roll press machine to produce a self-supporting electrode film.

The graphite, the SiC active material particles, the CNT, the PTFE, and the PVDF were mixed by a dry process without using a solvent at once. Thereafter, the PTFE was fibrillated, and the operation was performed in the same manner as described above to produce a self-supporting electrode film of a comparative example.

The copper foil (8 μm thick) was flat-pressed on these self-supporting electrode films at a weight of 0.2 t/cm² to produce electrodes (negative electrodes) of Examples and Comparative Examples. Further, an evaluation cell was produced by a normal method.

### Electrode Evaluation

In the electrode evaluation, the interfacial resistance between the electrode film and the foil was measured using an electrode resistance measurement system (RM2610, manufactured by HIOKI). The results are shown in FIG. 4.

### Cell Evaluation

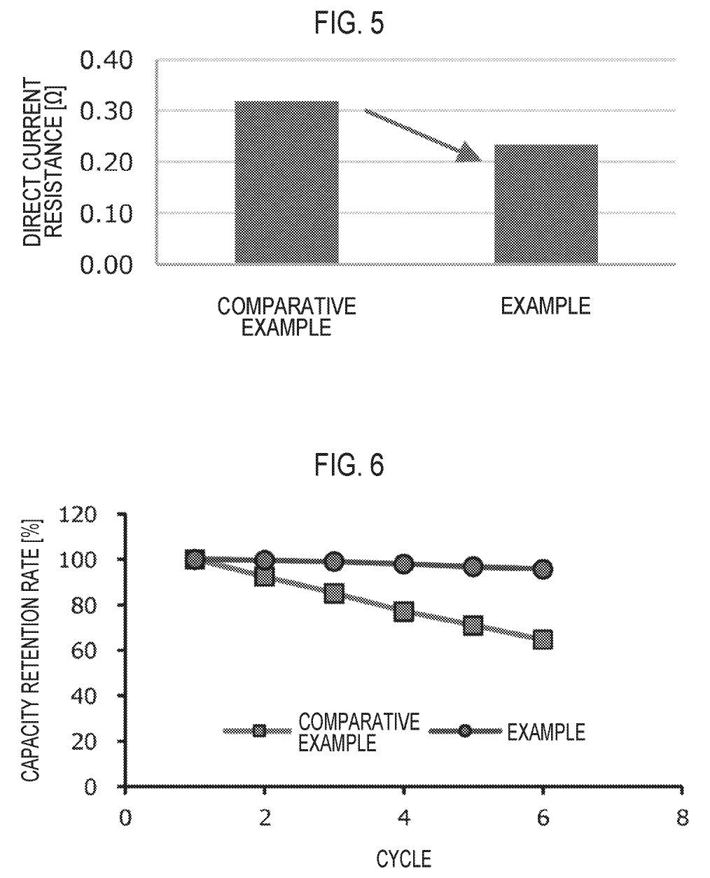

The evaluation cell was measured for impedance in a state of a SOC of 50% to calculate a direct current resistance. The results are shown in FIG. 5. In addition, the charging capacity and the discharging capacity were measured by 1/10C CCCV (constant current/constant voltage) charging. The voltage range was set to 3.0 V to 4.25 V, the number of cycles was set to 6, and a ratio of the discharging capacity to the first charging capacity (capacity retention rate) was calculated. The results are shown in FIG. 6.

As shown in FIG. 4, in the electrode of the Example, the interfacial resistance between the electrode film and the foil was lower than that of the electrode of the Comparative Example. In addition, as shown in FIG. 5, the direct current resistance in the cell was also lower in the cell of the Example than in the cell of the Comparative Example. From these results, it can be said that the electron conductivity of the SiC active material particles contributes to the decrease in resistance of the electrode film of the Example.

In the production of the self-supporting electrode film of the Example, a dry process using the SiC active material particles coated with the CNT on the surface was adopted. On the other hand, the self-supporting electrode film of the Comparative Example adopted a dry process in which the CNT was mixed at the same time as other electrode materials. Therefore, it can be said that the dispersion form of the CNT in these self-supporting electrode films is different. In the self-supporting electrode film of the Example, the CNT can be selectively unevenly distributed on the surface or in the vicinity of the surface of the SiC active material particles by using the CNT composite SiC active material particles. Therefore, it was found that the electron conductivity of the SiC active material particles could be improved, and as a result, the resistance of the self-supporting electrode film could be reduced.

In addition, as shown in FIG. 6, the capacity retention rate of the cell of the Example was improved as compared with that of the cell of the Comparative Example. In the self-supporting electrode film of the Example, since the CNT is selectively unevenly distributed on the surface or in the vicinity of the surface of the SiC active material particles, the cutting of the conductive path due to the expansion and contraction of the SiC due to charging and discharging can be suppressed, and as a result, the capacity retention rate can be increased.

The technical elements described in the present specification or the drawings exhibit technical usefulness alone or in various combinations and are not limited to the combinations described in the claims at the time of filing. In addition, the technology exemplified in the present specification or the drawings can achieve a plurality of objectives at the same time, and achieving one of the objectives has technical usefulness.

What is claimed is:

1. A self-supporting electrode film comprising:
carbon-based active material particles;
SiC active material particles;
carbon nanotubes unevenly distributed on a surface of the SiC active material particles or in a vicinity of the surface of the SiC active material particles; and
a first binder having a fibrillated form.

2. The self-supporting electrode film according to claim 1, wherein the self-supporting electrode film includes composite SiC active material particles having a composite form in which at least a part of the surface of the SiC active material particles is coated with the carbon nanotubes.

3. The self-supporting electrode film according to claim 2, wherein the first binder contains polytetrafluoroethylene.

4. A lithium ion secondary battery comprising the self-supporting electrode film according to claim 1 as a negative electrode film.

5. A manufacturing method of a self-supporting electrode film, the manufacturing method comprising:
removing a solvent from a mixture containing SiC active material particles, carbon nanotubes, and the solvent to prepare a first mixture containing composite SiC active material particles having a composite form in which at least a part of a surface of the SiC active material particles is coated with the carbon nanotubes;
mixing the first mixture, carbon-based active material particles, and a first binder that is fibrillatable, by a dry process to prepare a second mixture;
fibrillating the first binder in the second mixture to prepare a third mixture containing the first binder having a fibrillated form; and
pressurizing and molding the third mixture to produce the self-supporting electrode film.

6. The manufacturing method according to claim 5, wherein preparing the first mixture includes mixing the SiC active material particles and a paste in which the carbon nanotubes are dispersed in the solvent to obtain the mixture.
